(19) United States
(12) Patent Application Publication
(10) Pub. No.: US 2015/0180255 A1
(43) Pub. Date: Jun. 25, 2015

(54) METHOD AND SYSTEM OF CALCULATING BATTERY CHARGE TIME

(71) Applicants: Hyundai Motor Company, Seoul (KR); Kia Motors Corporation, Seoul (KR)

(72) Inventors: Woo Sung Kim, Hwaseong (KR); Dong Gil Ha, Changwon (KR)

(21) Appl. No.: 14/474,709

(22) Filed: Sep. 2, 2014

(30) Foreign Application Priority Data
Dec. 24, 2013 (KR) 10-2013-0162220

(51) Int. Cl. H02J 7/00

(52) U.S. Cl. CPC H02J 7/0052

(57) ABSTRACT

A system and method of calculating battery charge time are provided. The method includes determining, by a processor, a charge condition of a vehicle and calculating an initial voltage of a battery of the vehicle and a charge output of the battery, when the charging condition is determined to be slow charging In addition, the method includes calculating, by the processor, an average amount of charging current, based on the initial voltage and the charge output and calculating the battery charge time using the average amount of charging current.

### CROSS-REFERENCE(S) TO RELATED APPLICATION

The present application claims priority of Korean Patent Application Number 10-2013-0162220 filed on Dec. 24, 2013, the entire contents of which application is incorporated herein for all purposes by this reference.

### BACKGROUND

1. Field of the Invention

The present invention relates to a method and system for calculating battery charge time, and more particularly, to a method for calculating battery charge time that reduces errors in battery charge time estimation for various types of power supplies.

2. Description of the Related Art

Recently, in an effort to shift from the use of liquid energy sources to the use of alternate energy sources for the purpose of saving the liquid energy sources which are limited in supply and of preventing environmental pollution which has become increasingly severe, an electric vehicle (EV), a plug-in hybrid electric vehicle (MEV), etc. have been developed. In the EV or MEV, a motor is driven with power from a battery to run the vehicle at a constant speed or greater. Particularly, the electric vehicle runs on power from a battery. When a driver engages a pedal, a controller adjusts a gate frequency of an inverter based on the amount of pedal engagement, performing Pulse Width Modulation (PWM) on a direct current (DC), and the modulated current is supplied to the motor. The motor generates predetermined torque based on the amount of current supplied from the inverter to the motor to run the electric vehicle.

The electric vehicle is typically electrically charged using an alternating current power supply of 220 V for slow charging and a direct current power supply of 500 V for fast charging. Generally, to charge a high voltage battery which supplies electric power to electric vehicle, a battery is connected to a battery charger. There are two types of battery charging, slow charging and fast charging In slow charging, a battery is charged at a substantially low speed using current supplied from a general power supply. In fast charging, a battery is charged in substantially less time using current of a substantially high voltage. In other words, the charged amount of a battery depends on current applied to the battery and time during which the current is applied to the battery. For reference, “slow charging” as mentioned above is also referred to “on-board charging” as the same meaning.

The battery charge time which is taken (e.g., the amount of time required) to charge a high voltage battery is about 20 minutes for fast charging and about 5 to 10 hours for slow charging. The battery charge time varies depending on the specification of a power supply used for charging. Even though a high capacity charger for slow charge is used, when an external power supply is substantially low in the specification, the charge time increases. Accordingly, it is necessary to accurately calculate the battery charge time and inform a driver of the accurate charge time.

A conventional method of calculating battery charge time for slow charging has been developed. In this method, an average amount of current used for a previous charge is recorded and the average value is used for the subsequent charge. In particular, when an external power supply for a battery charge is changed, that is, when the specification of the external power supply for the previous charge and the specification of the external power supply for the subsequent charge differ, errors may occur in estimating the battery charge time since the amount of current obtained through the previous charge may not be suitable for the subsequent charge that uses an external power supply with a different specification. For example, when the rated power of a power supply used for a previous charge is 6 kW and the recorded average current is 15 A while the rated power of a power supply used for the subsequent charge is 2 kW and the average current used for the following charge is 5 A, the battery charge time increases by three times as long.

The foregoing is intended merely to aid in the understanding of the background of the present invention, and is not intended to mean that the present invention falls within the purview of the related art that is already known to those skilled in the art.

### SUMMARY

Accordingly, the present invention provides method and system for calculating battery charge time which may reduce errors in estimating the battery charge time according to the specification of a given power supply.

According to one aspect, a method for calculating battery charge time, may include: determining a charge condition of a vehicle; calculating an initial voltage of a battery and a charge output of the battery, when the charging condition is slow charging; calculating an average amount of charging current, based on the initial voltage and the charge output; and calculating the battery charge time using the average amount of charging current.

The calculation of the initial voltage and the charge output of the battery may be implemented based on a voltage and a current of the battery. The method of charging may further include displaying the calculated battery charge time. The displaying of the battery charge time may include displaying the calculated battery charge time during a charge while restricting a temporal change in the calculated battery charge time. The calculation of the average amount of charging current may be a calculation using a table in which the charge outputs and the initial voltages previously calculated are mapped. The calculation of the battery charge time may be a calculation based on the calculated average amount of charging current and a target charge capacity.

A method of calculating battery charge time according to one exemplary embodiment has an advantage of estimating more accurate battery charge time and displaying the estimated time to provide user convenience. This advantage boosts marketability of vehicles.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is an exemplary flowchart illustrating a method of calculating battery charge time according to one exemplary embodiment of the present invention;

FIG. 2 is an exemplary block diagram illustrating a system of an electric vehicle according to one exemplary embodiment of the present invention;

FIG. 3 is an exemplary graph illustrating fluctuations in voltage an current over time for slow charge according to one exemplary embodiment of the present invention; and

FIG. 4 is an exemplary table in which initial voltages and output powers are mapped according to one exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Specific structural and functional descriptions of exemplary embodiments of the present invention disclosed herein are only for illustrative purposes of the embodiments of the present invention. The present invention may be embodied in many different forms without departing from the spirit and significant characteristics of the present invention. Therefore, the exemplary embodiments of the present invention are disclosed only for illustrative purposes and should not be construed as limiting the present invention. Reference will now be made in detail to various exemplary embodiments of the present invention, specific examples of which are illustrated in the accompanying drawings and described below, since the exemplary embodiments of the present invention can be variously modified in many different forms. While the present invention will be described in conjunction with exemplary embodiments thereof, it is to be understood that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the present invention as defined by the appended claims.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between,” “directly between,” “adjacent to,” or “directly adjacent to,” should be construed in the same way.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

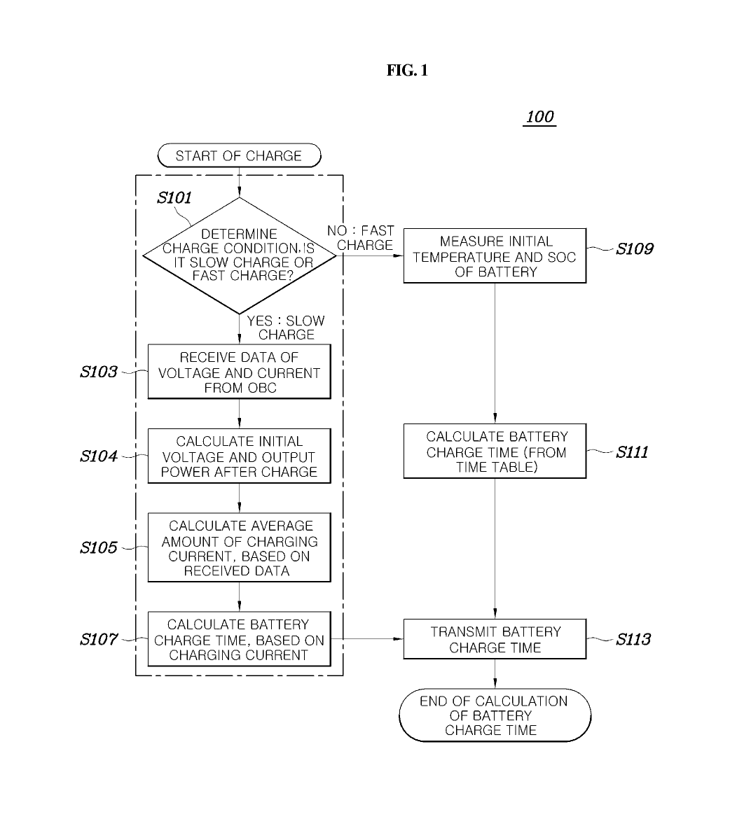

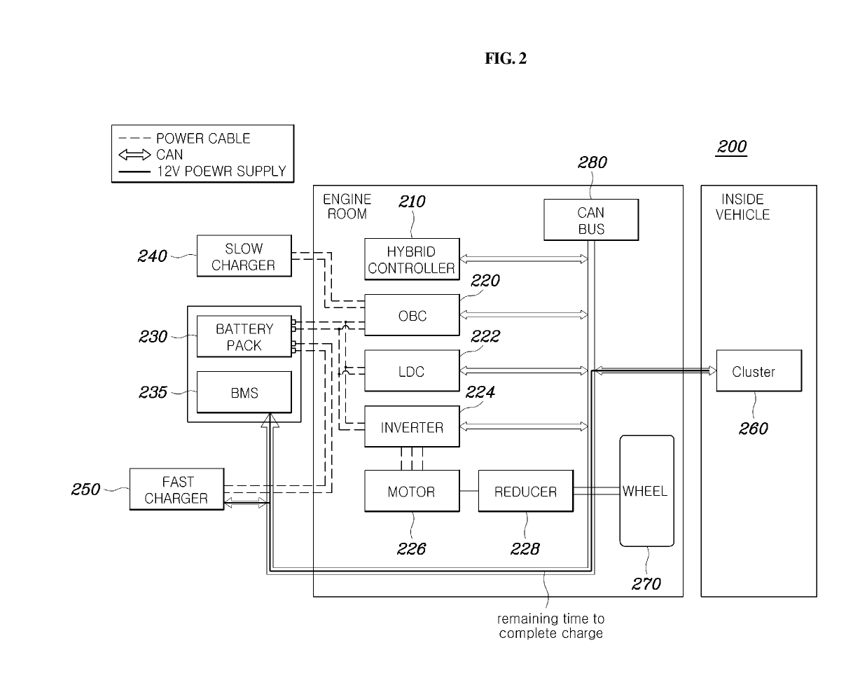

Hereinbelow, exemplary embodiments of the present invention will be described in detail with reference to the accompanying drawings Throughout the drawings, the same reference numerals will refer to the same or like parts. FIG. 1 is an exemplary flowchart illustrating a method of calculating battery charge time according to one exemplary embodiment and FIG. 2 is an exemplary block diagram schematically illustrating a system of an electric vehicle according to one exemplary embodiment.

A method 100 of charging battery charge time according to one exemplary embodiment will be described with reference to FIGS. 1 and 2. The method 100 may include determining, by a processor, a charging a condition of a vehicle (Step S101), receiving, by the processor, data of a current and voltage of a battery (Step S101) when the charging condition is determined to be slow charging, calculating, by the processor, an initial voltage and output power of the battery based on the received data (Step S104), calculating, by the processor, an average amount of charging current from a table in which initial voltages and output power are mapped, according to the calculated initial voltage and output power (Step S105), and calculating, by the processor, the battery charge time based on the calculated average amount of current and a target charge capacity (Step S107). The calculation of the output power and the initial voltage may be performed using values of an output voltage and a current which may be stabilized among values of the received output voltage and current of the battery.

When charging is initiated, a Battery Management System (BMS) 235 may be configured to determine a charging condition of a battery, i.e. slow charging or fast charging in Step S101. In particular, a processor of the BMS may be configured to perform the calculation. When the charging condition is determined to be slow charging, the BMS 235 may be configured to receive data of a voltage and a current from an On-Board Charger (OBC) 220 in Step S103. Then, an average value of charging current may be calculated from the data of the received voltage and current, in Step S105. The BMS 235 may be configured to calculated the battery charge time by dividing the calculated average amount of charging current by an amount of current required for charging, in Step S107.

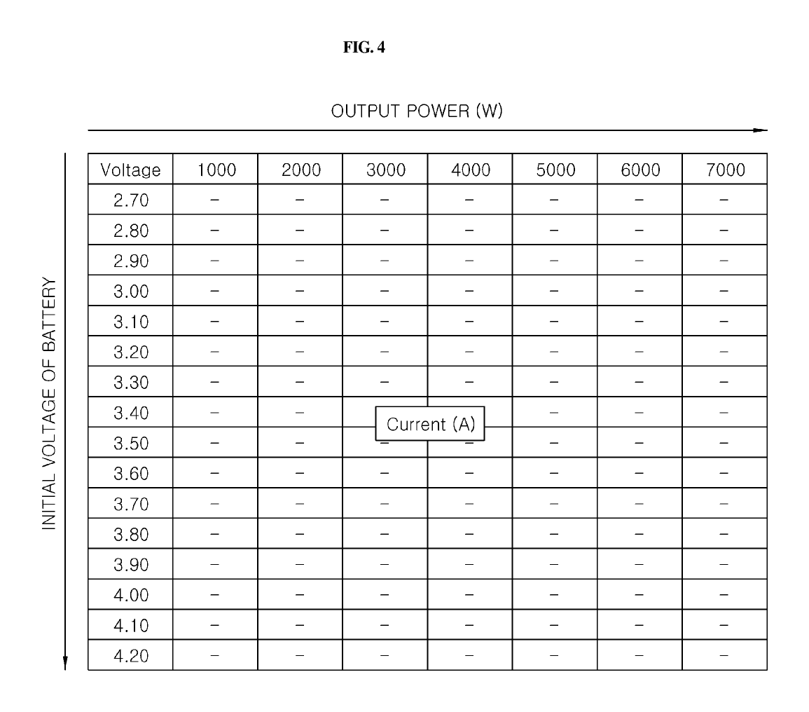

When the charging condition is determined to be fast charging, the BMS 235 may be configured to measure a State of Charge (SOC) and an initial temperature of a high voltage battery pack 230, in Step S109. The battery charge time required for charging may be calculated by referencing a table and based on the measured initial voltage and SOC of the battery, in Step S111. The battery charge time calculated in Step S107 or Step S111 may be transmitted to a cluster 260 or a fast charger 250 from the BMS 235, in Step S113. The data of voltage and current received from a slow charger 240, the average value of charging current calculated based on the received data, and the measured initial temperature and SOC may be stored in an additional storage device. For the slow charging, when calculating the battery charge time, the BMS 235 which may be configured to communicate with the OBC 220 may be configured to receive the data of voltage and current, calculate the initial voltage and output power of the battery based on the received data, and calculate the average amount of charging current using the table shown in FIG. 4 in which initial voltages and output power which may be preliminarily obtained are mapped.

The method of calculating the battery charge time according to the exemplary embodiment may further include displaying, by the processor, the calculated battery charge time. In the displaying of the calculated battery charge time, the battery charge time calculated during a charge while limiting a temporal change in the battery charge time may be displayed. In other words, since the battery charge time may continuously fluctuate during a charge, the battery charge time may be displayed by limiting the temporal change in the battery charge time. A display for displaying the battery charge time may be the cluster installed within a vehicle, for the slow charge, or the fast charger 250 itself, for the fast charge.

A system 200 of an electric vehicle may include a hybrid controller 210, an on-board charger (OBC) 220, a Low voltage Direct current Converter (LDC) 222, an inverter 224, a motor 226, a reducer 228, a high voltage battery pack 230, a BMS 235, a slow charger 240, a fast charger 250, and a cluster 260. The hybrid controller 210 may be configured to perform Controller Area Network (CAN) communication with the BMS 235. The OBC 220, LDC 222, inverter 224, fast charger 250, and cluster 260 may be configured to perform the CAN communication with the hybrid controller 210 and BMS 235. When the slow charger 240 is connected, the battery pack 230 may be charged via the OBC 220, and battery charge time calculated in the BMS 230 may be transmitted to the cluster 260 to notify a driver of the battery charge time.

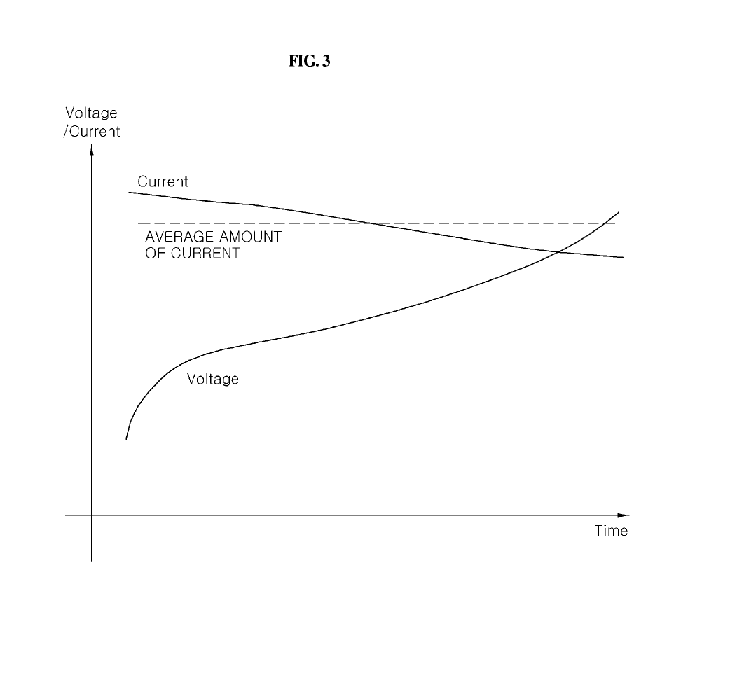

FIG. 3 is an exemplary graph illustrating fluctuations in voltage and current over time for slow charging according to one exemplary embodiment. At the time of slow charging, the charged voltage of the battery may increase over time, reducing a voltage difference. Accordingly, the charging current may decrease. In other words, the charging current may be determined based on the initial voltage and output power, the charged voltage of the battery may increase as the charging process progresses according to the charging current, and finally the charging current may decrease.

FIG. 4 is an exemplary table in which initial voltages and output powers are mapped according to one exemplary embodiment. The current table which may be preliminarily mapped (e.g., may be previously mapped) may include the initial voltages and output powers. In other words, the average amount of current may be obtained according to the initial voltage and output power from the mapped current table, and the battery charge voltage may be calculated based on the average amount of charging current obtained from the table, and a target charge capacity.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method of calculating battery charge time, comprising:
determining, by a processor, a charge condition of a vehicle;
calculating, by the processor, an initial voltage of a battery of the vehicle and a charge output of the battery, when the charging condition is determined to be slow charging;
calculating, by the processor, an average amount of charging current, based on the initial voltage and the charge output; and
calculating, by the processor, the battery charge time using the average amount of charging current.

2. The method according to claim 1, wherein the initial voltage and the charge output of the battery is calculated based on a voltage and a current of the battery.

3. The method according to claim 1, further comprising:
displaying, by the processor, the calculated battery charge time.

4. The method according to claim 3, wherein the displaying of the battery charge time includes:
displaying, by the processor, the calculated battery charge time during a charge while restricting a temporal change in the calculated battery charge time.

5. The method according to claim 1, wherein the calculating of the average amount of charging current includes a calculation from a table in which the charge outputs and the initial voltages calculated beforehand are mapped.

6. The method according to claim 1, wherein the calculating of the battery charge time includes a calculation based on the calculated average amount of charging current and a target charge capacity.

7. A system of calculating battery charge time, comprising:
a memory configured to store program instructions; and
a processor configured to execute the program instructions, the program instructions when executed configured to:
determine a charge condition of a vehicle;
calculate an initial voltage of a battery of the vehicle and a charge output of the battery, when the charging condition is determined to be slow charging;
calculate an average amount of charging current, based on the initial voltage and the charge output; and
calculate the battery charge time using the average amount of charging current.

8. The system of claim 7, wherein the initial voltage and the charge output of the battery is calculated based on a voltage and a current of the battery.

9. The system of claim 7, wherein the program instructions when executed are further configured to:
display the calculated battery charge time.

10. The system of claim 9, wherein the program instructions when executed are further configured to:
display the calculated battery charge time during a charge while restricting a temporal change in the calculated battery charge time.

11. The system of claim 7, wherein the calculation of the average amount of charging current includes a calculation from a table in which the charge outputs and the initial voltages calculated beforehand are mapped.

12. The system of claim 7, wherein the calculation of the battery charge time includes a calculation based on the calculated average amount of charging current and a target charge capacity.

13. A non-transitory computer readable medium containing program instructions executed by a processor, the computer readable medium comprising:
program instructions that determine a charge condition of a vehicle;
program instructions that calculate an initial voltage of a battery of the vehicle and a charge output of the battery, when the charging condition is determined to be slow charging;
program instructions that calculate an average amount of charging current, based on the initial voltage and the charge output; and
program instructions that calculate the battery charge time using the average amount of charging current.

14. The non-transitory computer readable medium of claim 13, wherein the initial voltage and the charge output of the battery is calculated based on a voltage and a current of the battery.

15. The non-transitory computer readable medium of claim 13, further comprising:
program instructions that display the calculated battery charge time.

16. The non-transitory computer readable medium of claim 15, further comprising:
program instructions that display the calculated battery charge time during a charge while restricting a temporal change in the calculated battery charge time.

17. The non-transitory computer readable medium of claim 13, wherein the calculation of the average amount of charging current includes a calculation from a table in which the charge outputs and the initial voltages calculated beforehand are mapped.

18. The non-transitory computer readable medium of claim 13, wherein the calculation of the battery charge time includes a calculation based on the calculated average amount of charging current and a target charge capacity.
